(19) United States
(12) Patent Application Publication
(10) Pub. No.: US 2012/0159985 A1
(43) Pub. Date: Jun. 28, 2012

(54) FORMED ALUMINUM FOIL BASED HOSE

(76) Inventor: ROGER CLIVE PALMER, Cleveland Hts., OH (US)

(21) Appl. No.: 13/325,589

(22) Filed: Dec. 14, 2011

Related U.S. Application Data
(60) Provisional application No. 61/422,803, filed on Dec. 14, 2010.

(51) Int. Cl. F28F 9/04; F25B 1/00; B23P 19/04

(52) U.S. Cl. 62/498; 165/178; 29/428

(57) ABSTRACT

A hose and method of forming the hose are disclosed. The hose includes a first end portion for coupling the hose to a first component and a second end portion for coupling the hose to a second component. The first end portion and the second end portion are connected by a length of the hose. The hose has two refrigerant barrier layers extending along its length between the first end portion and the second end portion, and a tubular layer surrounding the second refrigerant barrier layer. At least one of the refrigerant barrier layers is a metal barrier layer. The length of hose has a flexible hose section and a substantially inflexible hose section. The flexible hose section is located between the substantially inflexible hose section and one of the end portions of the hose.

### CROSS REFERENCE TO RELATED APPLICATIONS

The present application claims the benefit of the filing date of U.S. Provisional Application Ser. No. 61/422,803, filed Dec. 14, 2010, the disclosure of which is incorporated herein by reference in its entirety.

### TECHNICAL FIELD

The present invention relates generally to hoses, and more particularly to hoses for conveying a fluid such as refrigerant in a refrigeration system.

### BACKGROUND

Low permeation hoses are often used in systems to eliminate or reduce escape and/or infiltration of vapors and/or gases. For example, such hoses may be used in refrigeration systems to prevent leakage of refrigerant vapors from the system into the environment. Such hoses are also common in fuel systems for preventing fuel vapors from escaping to the environment.

Another application of such hoses is in connection with heating systems for supplying and returning water (or other fluid) from one or more heat exchangers. In such applications, low permeation hoses are used to prevent oxygen from entering the heating system, which can result in corrosion of various components such as pumps and valves.

Low permeation hoses typically include an inner tube for carrying a fluid, and a vapor barrier layer surrounding the inner tube. Various other layers typically may surround the vapor barrier layer, such as a braiding, an outer tube, a cover or outer sheath, etc.

### SUMMARY

The present invention provides a refrigerant hose having two barrier layers, one of which is formed from a metal material. The hose is formed to have both flexible and rigid sections, which may facilitate the installation of the hose in areas where space is at a premium, such as in an engine compartment of a vehicle, a condenser unit or evaporator unit in an air conditioning system, a standalone air conditioning unit, or another limited-space environment. Forming sections of the hose as described herein can eliminate the need to connect several hoses and/or tubes together to navigate around the various components contained in the limited space. Thus, several hoses and/or tubes connected to one another with fittings and/or joints can be replaced by a single continuous low permeation hose that directly connects one component of the system to another component of the system. The hose can therefore simplify the system by reducing the number of components and connections that have to be made, and also increase reliability by eliminating unnecessary fittings and/or joints that provide potential leak paths for the refrigerant in the system.

Accordingly, the present invention provides a hose having a first end portion for coupling the hose to a first component of a system and a second end portion for coupling the hose to a second component of the system. The first end portion and the second end portion are connected by a length of the hose. The hose has a first refrigerant barrier layer extending between the first end portion and the second end portion along the length of the hose, a second refrigerant barrier layer extending between the first end portion and the second end portion along the length of the hose and surrounding the first refrigerant barrier layer, and a tubular layer surrounding the second refrigerant barrier layer. At least one of the refrigerant barrier layers is a metal barrier layer. The length of hose has a flexible hose section and a substantially inflexible hose section. The flexible hose section is located between the substantially inflexible hose section and one of the end portions of the hose.

According to one embodiment, one of the layers of the hose is a thermoformable material and the substantially inflexible hose portions of the hose are thermoformed.

According to another embodiment, a sleeve may be attached to the hose and formed so as to limit the flexibility of the hose at the substantially hose inflexible hose sections.

According to another aspect, the invention provides a method of making a hose. The method includes forming a fluid conduit that extends along a length of hose between a first end portion and a second end portion by surrounding a first refrigerant barrier layer with a second refrigerant barrier layer, and surrounding the second refrigerant barrier layer with a tubular layer. The first refrigerant barrier layer and the second refrigerant barrier layer extend along the length of the hose and at least one of the refrigerant barrier layers is a metal barrier layer. The method also includes limiting the flexibility of a section of the length of the hose to form a substantially inflexible hose section, the substantially inflexible hose section is spaced from at least one of the first end portion and the second end portion by a flexible hose section.

Further features of the invention will become apparent from the following detailed description when considered in conjunction with the drawings.

### BRIEF DESCRIPTION OF THE DRAWINGS

Embodiments of this invention will now be described in further detail with reference to the accompanying drawings, in which:

FIG. 1 is an exemplary schematic diagram of an air conditioning system in accordance with aspects of the invention;

FIG. 2 is a perspective cut-away view of an exemplary hose in accordance with aspects of the invention;

FIG. 3A is an exploded view of a hose assembly in accordance with aspects of the invention;

FIG. 3B is a hose assembly including the hose of FIG. 2;

FIG. 3C shows the hose of FIG. 3B having substantially inflexible hose sections and flexible hose sections;

FIG. 3D shows the hose assembly of FIG. 3B in which the substantially inflexible hose sections are heat formed; and

FIG. 3E shows the hose assembly of FIG. 3B in which the substantially inflexible hose sections are formed by sleeves surrounding the hose.

### DETAILED DESCRIPTION

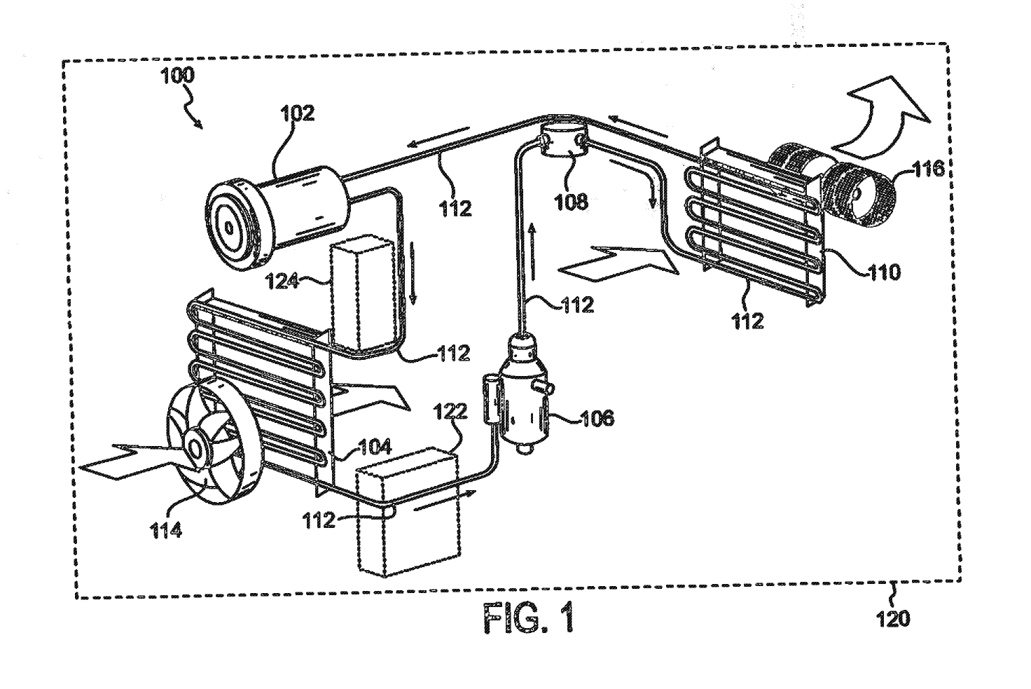

Referring to the drawings in detail, and initially to FIG. 1, an exemplary air conditioning system 100 is shown in schematic form. The air conditioning system 100 can include a compressor 102, a condenser 104, a receiver 106, an expansion valve 108 and an evaporator 110. The components of the air conditioning system 100 are coupled to one another to form a circuit by one or more conduits 112 that are suitable for conveying a fluid, such as a refrigerant, through the system 100. As described in more detail below, the conduit(s) 112 may be a low permeation hose that has one or more substantially inflexible hose sections and one or more flexible hose sections. FIG. 1 is one exemplary embodiment of an air conditioning system in which the hose with substantially inflexible and flexible hose sections can be used. Other system arrangements, which may have more or fewer components, are possible.

The compressor 102 receives fluid from the evaporator 110 and increases the fluid pressure. From the compressor 102, the fluid flows to the condenser 104 where it is condensed to a liquid state. The condenser 104 typically is associated with a fan 114 which flows air across the condenser 104 to absorb heat from the fluid, which causes it to condense. From the condenser 104, the fluid flows to the receiver 106 (also referred to as an accumulator). The receiver 106 accumulates the fluid before it flows to the expansion valve 108. The expansion valve 108 reduces the pressure of the fluid before it flows to the evaporator 110. Typically, the evaporator 110 is associated with a fan 116 which causes air to flow across the evaporator 110. Heat from the air flowing across the evaporator 110 is absorbed by the fluid in the evaporator 110 to cool the air. The fluid then flows from the evaporator 110 back to the compressor 102 and the cycle continues.

The components of the system 100 of FIG. 1 are arranged within a limited space indicated generically by reference numeral 120. The space 120 may be any limited-space environment. For example, the space 120 may be an engine compartment of a vehicle, a space for installation of an air conditioning system, a compressor or condenser unit, or another space. The conduits 112 can be formed to navigate around and/or through the various components contained in the space 120. For example, the conduit 112 connecting the condenser 104 and the receiver 106 can be formed to curve around component 122 and/or the conduit 112 connecting the compressor 102 to the condenser 106 can be formed to curve around component 124. It should be appreciated that components 122 and 124 are illustrative of any component that can located anywhere within space 120 that the conduits 112 may be formed around. Furthermore, any or all of the conduits may be formed around these or other components contained in the space 120.

Forming the hose with substantially inflexible and flexible hose sections can facilitate the installation of the hose around the various components in the space 120. For example, some air conditioning systems utilize conduits that are composed of multiple hoses and/or rigid tubes that are joined to one another by intermediate connectors or joints. Such systems are especially prevalent in the automotive market. These conduits can be replaced by a single, continuous hose having formed and flexible sections as described herein. By forming sections of the hose, the connections between the system components can be simplified to eliminate such intermediate connections, thereby allowing the various components (e.g., compressor, condenser, evaporator, receiver, and expansion valve) of the air conditioning system to be directly connected to one another without any intermediate couplers/fittings or joints along the length of the hose that connects the components. The hose described herein therefore can lower the cost of the system by reducing the number of components and connections that have to be made, and also increase reliability by eliminating fittings and joints that provide potential leak paths for the refrigerant in the system.

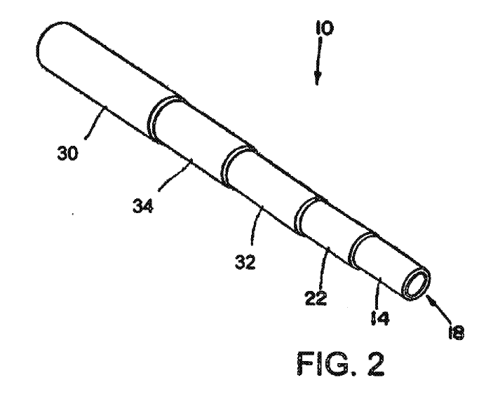

FIG. 2 is an exemplary embodiment of a hose 10 that can be used as a conduit 112 in the air conditioning system 100. The hose 10 includes a first refrigerant barrier layer 14, a second refrigerant barrier layer 22 surrounding the first refrigerant barrier layer 14, and at least one tubular layer 30 surrounding the second refrigerant barrier layer 22. At least one of the barrier layers can be a metal barrier layer, such as a layer of aluminum foil or an aluminum coated plastic film. One barrier layer may function as a primary barrier to the permeation of fluid contained in the hose, and the other barrier layer may function as a secondary or backup barrier to the permeation of fluid contained in the hose. The barrier layers also may inhibit the permeation of moisture through the layers of the hose and into the fluid contained therein.

In the embodiment of FIG. 2, the first refrigerant barrier layer 14 forms a fluid conduit through the hose and also functions as the primary barrier to the permeation of fluid (such as refrigerant) from the hose. The first refrigerant barrier layer 14 may be composed of any suitable material, such as an elastomer. The elastomer (or other material from which the first refrigerant barrier layer 14 is formed) may promote bonding of the first refrigerant barrier layer 14 to the second refrigerant barrier layer 22. In one exemplary embodiment, the first refrigerant barrier layer 14 is formed from nylon.

Continuing to refer to FIG. 2, the second barrier layer 22 may function as a secondary or backup barrier layer to permeation of refrigerant from the hose such that any fluid that may permeate through the first refrigerant barrier layer 14 can be inhibited from further permeation through the layers of the hose by the second barrier layer. The second barrier layer 22 may be formed from any suitable material. In one embodiment, the secondary barrier layer 22 is a metal barrier layer formed from a metal, for example, a thin layer of aluminum foil or an aluminum coated plastic film. The second barrier layer 22 may bend and flex with the other layers of the hose and without plastic deformation. That is, when the hose is bent, the second barrier layer 22 does not provide enough structural rigidity to the hose to cause the hose to retain its bent shape. Though it is possible that the other layers of the hose may cause the hose to retain its bent shape.

The tubular layer 30 may be a cover or other protective sheath for the hose and may be formed from a material, which when heated can be formed by pressure and/or vacuum (also referred to as a “thermoformable material”). Example of suitable materials include thermoplastic materials, for example, acrylonitrite butadiene styrene or vinyl benzene. Additionally or alternatively, other layers of the hose (e.g., layers 32 and 34) may be formed from a thermoformable material.

As shown, the hose 10 also may include additional tubular layers 32 and 34 surrounding the second refrigerant barrier layer 22. For example, one tubular layer 32 may adhere to the second refrigerant barrier layer 22 and the other tubular layer 34 may be a layer for reinforcement (polyester/metallic wire, para-aramid synthetic fiber, or other suitable braid, etc.). Other layers can also be provided between and/or in addition to the illustrated layers without departing from the scope of the invention.

Other suitable hoses are described in U.S. patent application Ser. No. 12/741,870, entitled “Aluminum Foil Based Hose”, filed on Sep. 30, 2008 and published as U.S. Patent Application 2011/0017338 and in U.S. Pat. No. 7,857,010 entitled “Low Permeability Hose System”, which issued on Dec. 28, 2010, the disclosures of which are incorporated herein by reference in their entirety. As will be appreciated the above-referenced hoses can have one or more substantially inflexible hose sections formed by constructing the hose with at least one layer that is a thermoformable material and/or by at least partially surrounding the hose with a sleeve to restrict the flexibility of the hose.

The above-described hoses are particularly well-suited for commercial and automotive refrigeration systems, as well as air conditioning systems found in agriculture and off-highway vehicles, for example. Additionally, such hoses also are particularly well-suited for residential applications. Examples of such systems include R410 refrigerant or equivalent systems (e.g., residential applications), R134a refrigerant or equivalent systems (e.g., mobile applications), and/or R477 refrigerant or equivalent systems (e.g., mobile applications). The hoses can be used in a wide variety of other systems as well, including other conventional and future refrigerant systems.

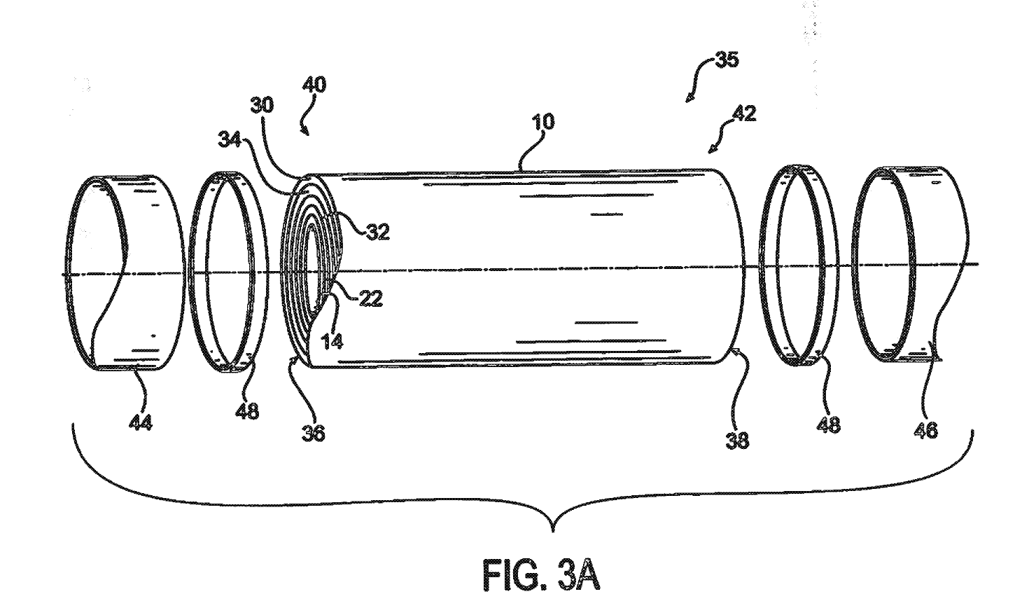

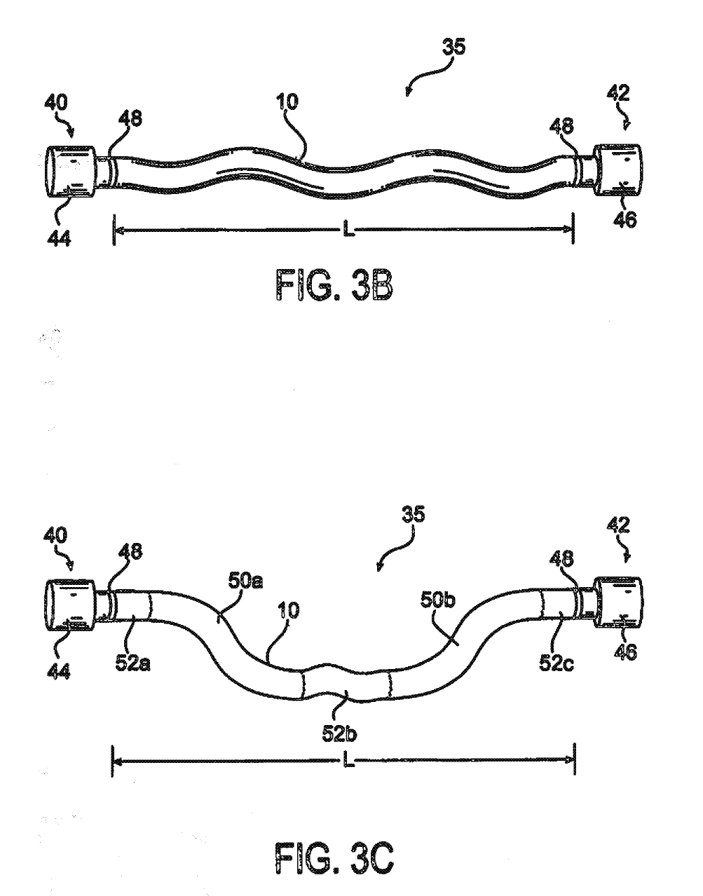

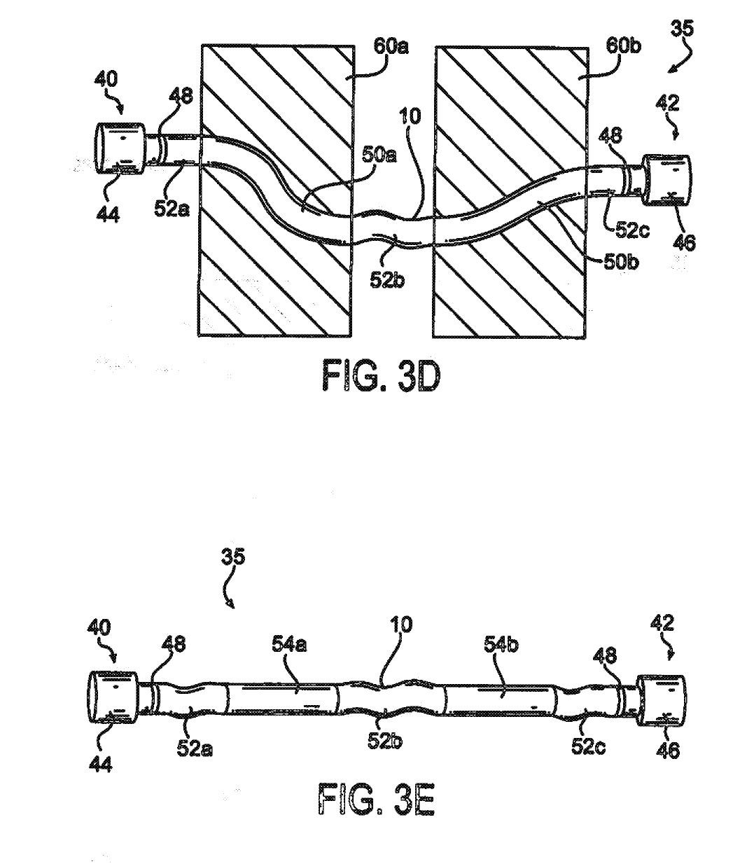

FIG. 3A is an exploded view of a hose assembly 35. The hose assembly 35 includes the low permeation hose 10. As shown, the barrier layers 14 and 22 extend substantially along entire length of the hose. In one embodiment, the first refrigerant barrier layer 14 and the second refrigerant barrier layer 22 are continuous layers of material that extend from one axial end of the hose 36 to the other axial end of the hose 38. The hose 10 can have a first end portion 40 and a second end portion 42 for coupling the hose to respective couplers 44 and 46. The couplers 44 and 46 may be used to connect the hose assembly to first and second components of an air conditioning system such as the components of the system shown in FIG. 1.

The hose assembly 35 is shown in FIG. 3B. The end portions 40 and 42 of the hose are connected by a length L of the hose. The length L of hose is free from any fittings, couplers or other joints. The first refrigerant barrier layer 12 extends between the first end portion 40 and the second end portion 42 along the length L of the hose 10. The second refrigerant barrier 22 layer also extends between the first end portion 40 and the second end portion 42 along the length L of the hose 10. Preferably, the refrigerant barrier layers 14 and 22 extend through the end portions 40 and 42 of the hose 10 and at least partially into a portion of couplers 44 and 46.

The couplers 44 and 46, which are connected respective end portions 40 and 42 of the hose, are used to effect connection between the hose 10 and the components of the air conditioning system (e.g., the components in the system 100 of FIG. 1). The couplers may be coupled to the hose in a substantially leak-free manner such that when the hose is pressurized with a refrigerant, refrigerant does not leak through the connection between the end portions 40 and 42 and the couplers 44 and 46 into the environment.

The first and second end portions 40 and 42 include those portions of the hose 10 that may be restricted from flexible movement by the couplers 44 and 46. For example, one or both couplers and may have a nipple that extends into and engages the interior wall of the hose and restricts the flexibility of the hose, or the coupler may have one or more exterior clips 48 that engage the outer layer 30 of the hose 10 to limit its flexibility. Such inflexible portions of the hose are considered to be part of the end portions 40 and 42 of the hose 10 that are connected by the length L of hose.

With additional reference to FIG. 3C, the length L of hose includes substantially inflexible hose sections (e.g., sections 50a and 50b) and flexible hose sections (e.g., sections 52a, 52b, 52c). At least one of the flexible hose sections is located between a substantially inflexible hose section and one of the end portions of the hose. For example, flexible hose section 52a is located between substantially inflexible hose section 50a and end portion 40. The length L of hose also has at least one flexible hose section 52b between a substantially inflexible hose section (e.g., 50a) and the other end portion 42 of the hose. Additionally, the length L of hose can have a flexible hose section 52c that is located between substantially inflexible hose section 50b and end portion 42. The length L of hose also can have a flexible hose section 52b between substantially inflexible hose sections 50a and 50b. Although illustrated as having two substantially inflexible sections and three flexible sections, it should be appreciated that the hose can be formed with more or fewer flexible/substantially inflexible sections.

As shown, the substantially inflexible hose sections (e.g., sections 50a and 50b) are between the first end portion 40 of the hose 10, which includes the end portion 40 of the hose that is restricted from flexing by coupler 44, and the second end portion 42 of the hose 10, which includes the portion of the hose 10 that is restricted from flexing by coupler 46. For example, as shown in FIG. 3C, substantially inflexible hose section 50a is spaced from the first end portion 40 by flexible hose section 52a and substantially inflexible hose section 50b is spaced from the second end portion 42 by flexible hose section 52c. Although the substantially inflexible hose sections in FIG. 3C are both shown as being spaced from the end portions of the hose, it should be appreciated that only one substantially inflexible hose section may be spaced from the end portion of the hose. Alternatively, the substantially inflexible hose sections can be spaced from both end portions of the hose. Additionally, the hose may have more or fewer flexible and substantially inflexible hose sections than shown in FIG. 3C.

The substantially inflexible hose sections may be formed, for example, by heat forming a layer of hose as shown in FIG. 3D or by at least partially surrounding the hose by a sleeve as shown in FIG. 3E. As used herein, “substantially inflexible” means substantially rigid (e.g., not easily flexed back and forth), and “flexible” means pliable (e.g., easily flexed back and forth).

As shown in FIG. 3D, one of the tubular layers of the hose can be constructed from a thermoformable material and one or more heat forms 60a and 60b, such as autoclaves, can be used to heat the sections of the hose and form them into a desired shape. The sections may be held in the desired shape until the thermoformable material is heat cured. Those sections of the hose that have been heat formed (e.g., sections 50a and 50b) will retain their formed shape while the section(s) of the hose that have not been heat formed (e.g., sections 52a, 52b, and/or 52c) will remain flexible.

As shown in FIG. 3E, the substantially inflexible hose sections of the hose also may be formed by a mechanical device, such as a sleeve that at least partially surrounds the tubular layers. FIG. 3E shows two sleeves 54a and 54b at least partially surrounding the hose. The sleeves may be formed from a material that can retain shape when bent for example, by being plastically deformed. The sleeve may be formed from metal (e.g., aluminum), which can be bent to a desired shape, and which rigidly hold the hose in the bent shape. Alternatively, the sleeve may be or a plastic material that has been preformed to a desired shape and slid longitudinally over the hose to rigidly hold the hose in the preformed shape. The sleeves may be tubular or may have another shape, such as a “C” shape, and may be snapped onto, crimped or otherwise attached at any desired position along the length of the hose.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A hose comprising:
a first end portion for coupling the hose to a first component of a system and a second end portion for coupling the hose to a second component of the system, the first end portion and the second end portion connected by a length of the hose; and
a first refrigerant barrier layer extending between the first end portion and the second end portion along the length of the hose, a second refrigerant barrier layer extending between the first end portion and the second end portion along the length of the hose and surrounding the first refrigerant barrier layer, and a tubular layer surrounding the second refrigerant barrier layer, wherein at least one of the refrigerant barrier layers is a metal barrier layer,
wherein the length of hose has a flexible hose section and a substantially inflexible hose section, the flexible hose section being located between the substantially inflexible hose section and one of the end portions of the hose.

2. The hose of claim 1, wherein the length of hose has a second flexible hose section between the substantially inflexible hose section and the other end portion of the hose.

3. The hose of claim 1, wherein second tubular layer comprises a thermoformable material, and the substantially inflexible hose section is formed by a heat curing a section of second tubular layer.

4. The hose of claim 2, wherein the thermoformable material is a thermoplastic.

5. The hose of claim 4, wherein the thermoplastic is acrylonitrite butadiene styrene or vinyl benzene.

6. The hose of claim 1, further comprising a mechanical device at least partially surrounding the second tubular layer at the substantially inflexible hose section.

7. The hose of claim 3, wherein the mechanical device is a rigid sleeve comprising an aluminum tube surrounding the second tubular layer.

8. A hose assembly for an air conditioning system, comprising the hose of claim 1 in combination with a coupler coupled to the first end portion of the hose.

9. The hose assembly of claim 8, further comprising a second coupler coupled to the second end portion of the hose, wherein the flexible hose section is between the substantially inflexible hose section and the second coupler.

10. The hose assembly of claim 9, wherein the hose further comprises a second flexible hose section located between the first coupler and the substantially inflexible hose section.

11. The hose of claim 9, wherein the length of hose does not have a coupler or fitting.

12. The hose of claim 9 connecting components of a vehicle air conditioning system having a first component and a second component, wherein the first coupler is coupled to the first component and the second coupler is coupled to the second component, and refrigerant is conveyed through the hose from the first component to the second component through the hose without passing though an intermediate coupler.

13. A method of making a hose comprising:
forming a fluid conduit that extends along a length of hose between a first end portion and a second end portion by surrounding a first refrigerant barrier layer with a second refrigerant barrier layer, and surrounding the second refrigerant barrier layer with a tubular layer, wherein the first refrigerant barrier layer and the second refrigerant barrier layer extend along the length of the hose and at least one of the refrigerant barrier layers is a a metal barrier layer; and
limiting the flexibility of a section of the length of the hose to form a substantially inflexible hose section, the substantially inflexible hose section being spaced from at least one of the first end portion and the second end portion by a flexible hose section hose.

14. The method of claim 13, wherein the tubular layer comprises a thermoformable material, and the step of limiting the flexibility of a portion of the hose comprises heat curing a longitudinal section of the tubular layer.

15. The method of claim 13, wherein limiting the flexibility of a portion of the hose comprises at least partially surrounding the second tubular layer with a rigid sleeve.

16. The method of claim 15, further comprising bending the sleeve.

17. An air conditioning system comprising:
a compressor,
a condenser for condensing fluid;
an expansion valve for reducing pressure of the fluid; and
an evaporator for at least partially evaporating the fluid,
wherein the compressor, the condenser, the expansion valve and the evaporator are coupled by conduits to form a circuit, and at least one of the conduits is a refrigerant hose having a first end portion for coupling the hose to one component of the air conditioning system, a second end portion for coupling the hose to another component of the air conditioning system, the first end portion and second end portion being connected by length of the hose, a first refrigerant barrier layer extending along the length of hose, a second refrigerant barrier layer surrounding the first refrigerant barrier layer and extending the length of the hose, and a tubular layer surrounding the second refrigerant barrier layer, wherein at least one of the refrigerant barrier layers is a metal barrier layer, and wherein the length of hose has a flexible hose section and a substantially inflexible hose section, the flexible hose section being located between the substantially inflexible hose section and one of the end portions of the hose.

18. The hose of claim 17, wherein the hose further comprises a second flexible hose section between the inflexible hose section and the other end portion.

19. The hose of claim 17, wherein second tubular layer comprises a thermoformable material, and the substantially inflexible hose section is formed by a heat curing a section of second tubular layer.
